(19) United States
(12) Patent Application Publication
(10) Pub. No.: US 2014/0165118 A1
(43) Pub. Date: Jun. 12, 2014

(54) METHOD AND END POINT FOR DISTRIBUTING LIVE CONTENT STREAM IN A CONTENT DELIVERY NETWORK

(71) Applicants: Armando Antonio García Mendoza, Madrid (ES); Xiaoyuan Yang, Madrid (ES); Parminder Chhabra, Madrid (ES); Arcadio Pando Cao, Madrid (ES); Pablo Rodriguez Rodriguez, Madrid (ES)

(72) Inventors: Armando Antonio García Mendoza, Madrid (ES); Xiaoyuan Yang, Madrid (ES); Parminder Chhabra, Madrid (ES); Arcadio Pando Cao, Madrid (ES); Pablo Rodriguez Rodriguez, Madrid (ES)

(73) Assignee: TELEFONICA, S.A., Madrid (ES)

(21) Appl. No.: 14/116,855

(22) PCT Filed: May 9, 2012
(86) PCT No.: PCT/EP2012/058515

§ 371 Date: Feb. 27, 2014

(30) Foreign Application Priority Data
May 12, 2011 (ES) P201130760

(51) Int. Cl. H04N 21/61; H04N 21/6587; H04N 21/262

(52) U.S. Cl. CPC H04N 21/61; H04N 21/26258; H04N 21/6587
USPC 725/90

(57) ABSTRACT

The method comprises the management and delivery of a requested live stream using a P2P-based architecture, where peers exchanging content with one another are end points of a CDN. The delivery of the requested live stream to one or more end users is performed from one or more of said end points. The requested live stream is split into segments that the serving end points, preferably, obtains from neighbouring end points and/or from the origin server of the live stream using a scheduling algorithm and depending on the availability of segments thereof.

The end point is designed for implementing the method of the invention.

### FIELD OF THE ART

The present invention generally relates, in a first aspect, to a method for distributing live content stream in a Content Delivery Network (CDN), and more particularly to a method comprising the managing and delivery of a requested live stream according to a P2P-based architecture, where peers are end points (also called content servers) of said CDN.

A second aspect of the invention relates to an end point for a CDN designed to implement the method of the first aspect.

### PRIOR STATE OF THE ART

Peer-to-peer (P2P) systems have been successful in distributing files to large number of users. P2P systems are also widely used for distribution of video content including video downloads (where users need to download the entire video file before they can watch the video) and live media streaming (such as Coolstreaming). Recently, new systems [1, 10, 11] have been designed to enable a video-on-demand (VoD) experience using P2P. However, such services implicitly assume that users view the content from start to finish at the playback rate. Support for DVD functionality (pause/resume, jump forward or backwards across a video) is a natural requirement for most VoD systems. Although many popular centralized systems (so called because they offer a dedicated stream between the content server of a content owner and the requesting end user) like Youtube [19], Netflix [20] and home theatre systems offer seek functionality, DVD functions are largely ignored by many P2P VoD systems.

Design of P2P based VoD systems with DVD functionality is non-trivial because of the lack of synchronization among end users that reduces the opportunity for P2P based sharing. As users jump around in a video, their chance for sharing decreases and requires content to be pulled from the origin server that stores the master copy of the content to ensure good user viewing experience. A good design requires low delay on performing DVD operations and a sustained play out rate while minimizing the amount of data pulled from the origin server. This involves finding the right peers, scheduling content to exchange at the right time, a non-trivial design task. While difficult to execute in a VoD environment, the design goals are similar for a live-streaming solution. The implementation of P2P based solutions are relatively easier to implement in a live-streaming environment without sustained load on the origin server since they provide peers with ample opportunities for sharing content. However, such a solution still provides considerable challenges in finding the right peers for scheduling data exchange among the peers.

The first P2P based video delivery systems were built for live video streaming and included tree-based overlays such as Slip-stream, and mesh-based overlays such as Coolstreaming and PPLive. The next generation video P2P systems were designed to support VoD, including BitOS [11], BASS [10], Redcarpet [1], Toast [14]. For instance, BiToS divides missing blocks into two sets (low priority and high priority), and schedule requests accordingly from peers and the server. BASS extends BitTorrent to provide VoD services, with a high dependency from the server. In [1], the authors show the benefits of network coding to simplify the segment-scheduling problem and provide high quality VoD services. In [6], the authors present an analytical formulation of the impact of various scheduling policies to optimize VoD performance. In [3], the authors describe the challenges faced by a commercial P2P VoD system deployed by PPLive, and propose content discovery, replication, and scheduling algorithms to deal with these challenges.

Recently, [12] [7] and [2] have discussed some of the issues that can arise when designing P2P systems that support DVD-like functionality. In particular, [12] introduced the concept of anchors to prefetch data in predefined points of the video and allow for jumps to such points. In Bulletmedia [2], the authors proposed a more aggressive proactive caching which proactively creates multiple copies of every segment on an overlay, thus reducing the dependence on the source. The goal is to ensure that all blocks are replicated in-overlay, regardless of when the set of active peers in the overlay will require them to support current playback. In [7] they propose a gossip protocol over a ring, where each peer keeps some near neighbours as well as some remote neighbours following a power-law radius, and show via simulations that they can handle random seeks.

In [21] the authors determine the fundamental tradeoffs and limitations on the origin server load and user experience using live end user jumping traces obtained from a deployment of a real system to validate their design choices. Using realistic end user jump patterns and a working implementation, they show that it is possible to achieve very good user experience without aggressively over-provisioning the system.

Many CDNs use either Microsoft's streaming media server [17] solution or Adobe's flash media server [18] to distribute live content streams. The servers in both cases serve a stream to each of the requesting end users. They also take advantage of IP multicast and dynamic streaming.

Both Octoshape [22] and Rawflow [16] are P2P based systems that are used to distribute content to requesting end users. End users who use Octoshape download a P2P based plug-in that is then used by the end user hosts for distributing content.

For Rawflow [16], end users known as Intelligent Content Distribution (ICD) clients contact the ICD server and begin receiving the stream from it. The player at the end user plays the stream as received by the ICD client. The ICD clients come together to form a grid. An ICD client also accepts connections from other clients in the grid to whom it may relay a part or whole stream it receives as requested. The ICD Client monitors the quality of the stream it is receiving and upon any reduction of quality or loss of connection it again searches the grid for available resources while continuing to serve the media player from its buffer. The buffer prevents interruption to the playback and ensures that the end-user experience is not affected.

Problems with Existing Solutions:

Most CDN operators use Microsoft's streaming media or Adobe's Flash media server to distribute content. The CDN service provider also has little control over how these solutions utilize the network and has little opportunity to optimize the network for content delivery, more so for live streams.

A number of P2P based systems presented above focus either on how to pre-fetch content across the swarm or how peers should relate to each other, and use simulations to evaluate simple random jump patterns, which could bias the design of the system. Aggressive pre-fetching could result in wasted origin server and peer resources if end user jumps don't occur (more so for a live stream), and matching peers is only one part of the design space and needs to be carefully combined with other design choices such as smart scheduling policies or efficient admission control strategies. Further, using the above systems in a CDN to distribute live content presents exceptional challenges, since users expect high quality videos with TV-like user experience even when performing DVD operations.

Most P2P-based solutions rely on end users to behave as peers to participate in content distribution. This requires end points to either download an application or download a plug-in for the browser in order to be part of the content delivery network. Pure P2P solutions thus use end user's computing resources, an unreliable infrastructure for what is meant to be reliable content distribution.

By using computing resources at end users, the content distributers shift their share of the bandwidth cost to the end users, a practice that does not provide reliable (or sufficient) bandwidth for high quality content exchange. Further, as part of end user agreement to use such a software, the said software also make claims to reserve the right to expand the scope of what the said software may do on an end user system [22] resulting in unpredictable action at the end user (like disabling the software). Given the unpredictability of such systems to distribute live content implies that they fail to attract sufficient users to gain critical mass to be part of a reliable infrastructure for live streaming.

Description of the Invention

It is necessary to provide an alternative to the existing state of the art that covers the gaps found therein, particularly those found in existing CDN designs that support live streaming that overload the origin server that is charged with distributing such a live stream.

To that end, the present invention relates, in a first aspect, to a method for distributing live content stream in a Content Delivery Network, comprising serving an entity of said Content Delivery Network, or CDN, a requested live stream to at least one end user, wherein the method is guided by a P2P-based architecture.

As per the method of the invention, the management and delivery of said requested live stream is performed using a P2P-based architecture, where peers are end points of said CDN exchanging content with one another, where the delivery of said requested live stream to said one or more end users is performed from at least one of said end points.

For a preferred embodiment, the method comprises said end point obtaining said requested live stream in pieces or segments into which it has previously been split, from an origin server and/or from neighbouring end points, depending on the availability thereof.

Other embodiments of the method of the first aspect of the invention are described according to claims 2 to 22, and in a posterior section related to the detailed description of several embodiments.

A second aspect of the invention relates to an end point for a CDN, which comprises a live-stream module implementing a scheduler including a live-point predictor module, a P2P download manager module and a live stream server module, for distributing live content stream by performing the actions of the method of the first aspect of the invention according to the embodiment described in appended claim 13.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 is a sequence diagram for implementing live-streaming in a service provider's CDN according to the method of the first aspect of the invention; and

FIG. 2 shows the live streamer module of the end point of the second aspect of the invention that is composed of three sub-modules.

### DETAILED DESCRIPTION OF SEVERAL EMBODIMENTS

The terminology and definitions that might be useful to understand the different embodiments of the present invention are as follows:

PoP: A point-of-presence is an artificial demarcation or interface point between two communication entities. It is an access point to the Internet that houses servers, switches, routers and call aggregators. ISPs typically have multiple PoPs.

Content Delivery Network (CDN): This refers to a system of nodes (or computers) that contain copies of customer content that is stored and placed at various points in a network (or public Internet). When content is replicated at various points in the network, bandwidth is better utilized throughout the network and users have faster access times to content. This way, the origin server that holds the original copy of the content is not a bottleneck.

URL: Simply put, Uniform Resource Locator (URL) is the address of a web page on the world-wide web. No two URLs are unique. If they are identical, they point to the same resource.

Bucket: A bucket is a logical container for a customer that holds the CDN customer's content. A bucket either makes a link between origin server URL and CDN URL or it may contain the content itself (that is uploaded into the bucket at the entry point). An end point will replicate files from the origin server to files in the bucket. Each file in a bucket may be mapped to exactly one file in the origin server. A bucket has several attributes associated with it—time from and time until the content is valid, geo-blocking of content, etc. Mechanisms are also in place to ensure that new versions of the content at the origin server get pushed to the bucket at the end points and old versions are removed.

A customer may have as many buckets as she wants. A bucket is really a directory that contains content files. A bucket may contain sub-directories and content files within each of those sub-directories.

Geo-location: It is the identification of real-world geographic location of an Internet connected device. The device may be a computer, mobile device or an appliance that allows for connection to the Internet for an end user. The IP-address geo-location data can include information such as country, region, city, zip code, latitude/longitude of a user.

Operating Business (OB): An OB is an arbitrary geographic area in which the service provider's CDN is installed. An OB may operate in more than one region. A region is an arbitrary geographic area and may represent a country, or part of a country or even a set of countries. An OB may consist of more than one region. An OB may be composed of one or more ISPs. Each region in an OB is composed of exactly one An OB has exactly one instance of Topology Server.

Partition ID: It is a global mapping of IP address prefixes into integers. This is a one-to-one mapping. So, no two OBs can have the same PID in its domain.

Next, each component of the CDN service provider's sub-systems is described. The infrastructure consists of Origin Servers, Trackers, End Points and Publishing Point.

Publishing Point: Any CDN customer may interact with the CDN service provider's infrastructure solely via the publishing point (sometimes also referred to as the entry point for simplicity). The publishing point runs a web services interface with users of registered accounts to create/delete and update buckets.

A CDN customer has two options for uploading content. The customer can either upload files into the bucket or give URLs of the content files that reside at the CDN customer's website. Once content is downloaded by the CDN infrastructure, the files are moved to another directory for post-processing. The post-processing steps involve checking the files for consistency and any errors. Only then is the downloaded file moved to the origin server. The origin server contains the master copy of the data.

For live content, the CDN customer merely gives provides the CDN with a URL of the live stream.

End Point: An end point is the entity that manages communication between end users and the CDN infrastructure. It is essentially a custom HTTP server.

hdr/hdx file: In live streaming, when content (of any format) is split, two kinds of files are created, hdr and hdx files. An hdr file is really a header file that contains header information about the media, resolution, bit-rate etc. and the hdx file is a circular buffer of URL of segments of the original live stream that reside at the live-splitter.

Tracker: The tracker is the key entity that enables intelligence and coordination of the CDN service provider's infrastructure. In order to do this, a tracker maintains (1) detailed information about content at each end point and (2) collects resource usage statistics periodically from each end point. It maintains information like number of outbound bytes, number of inbound bytes, number of active connections for each bucket, size of content being served, etc.

Origin Server: This is the server in the CDN service provider's infrastructure that contains the master copy of the data. Any end point that does not have a copy of the data can request it from the origin server. The CDN customer does not have access to the origin server. CDN service provider's infrastructure moves data from the publishing point to the origin server after performing sanity-checks on the downloaded data.

For live content, the live splitter serves as the origin server. Its buffer limits the amount of live content stored at the live splitter. This allows an end user to perform DVD operations on a live stream for duration equal to no more than the size of the buffer.

In this section, the design of live-streaming support at a service provider's CDN that relies on a P2P-based architecture is detailed. End points in the same datacenter that serve live content are treated as peers in this design. However, end users who request content are not treated as peers for the purpose of distributing content.

This invention relies on a P2P architecture that allows end points to exchange content with one another in a datacenter. Since end points in a datacenter are well provisioned, they do not suffer from the same computing and bandwidth limitations that traditional P2P-based systems [16][22] face that rely on end users as peers.

Next, a detailed description of how a CDN customer may set up distribution of live content and how a live signal is treated once it enters a service provider's CDN is provided. The architecture of the live-streaming module at an end point in a service provider's CDN and how the end points exchange content with one another when possible is also detailed, and also how the end points serve a requesting end user.

Next, the design and architecture of live-streaming in a service provider's CDN is described in detail for some embodiments.

Once a live stream is within the CDN service provider's ecosystem, it is segmented and a playlist of the segments is created. This segmenter serves as an origin server for the live-stream. The playlist is forwarded to the end points that requested the live stream. Once the end points receive the playlist, they exchange the segments of the playlist among one another when possible and get the segments from the origin server when necessary.

How a live stream is first associated with a live bucket that forms the basis for the delivery of live streams is detailed first.

Creating a Live-Bucket

Here, a live bucket is created and meta-data is associated with it. The content owner creates the live bucket at the CDN manager. When creating a live bucket, the address of the live splitter for the live stream is also specified.

The live bucket supports create, retrieve, update and delete API calls on a bucket. The live bucket also supports a variety of parameters that allows the content owner (the CDN customer) to set a number of content distribution properties on the bucket (i.e., start date, end date, geo-blocking, whitelist, blacklist, format of the output live stream, etc.). A statistics call on the bucket retrieves statistical information (bytes served by the live CDN stream).

The meta-data for the size of a segment is defined at the time a bucket is created. For ease of explanation, a segment size of 5 seconds is used. In addition, a playlist size of 12 segments is defined. So, one instance of a playlist of duration one minute has URLs of 12 segments. Every 30 seconds, a playlist is sent to the end points. This value is chosen so as not to overwhelm the origin server of the live stream for update requests. These values for segment duration and playlist size are used for illustration purposes only and do not restrict the scope of the invention.

In addition, a file level API is used to manage the live stream. A start/stop API call on a live bucket is used to either start or stop a stream. A status API call on a live bucket retrieves the current status of a live stream.

High-Level Architecture to get the Live Stream

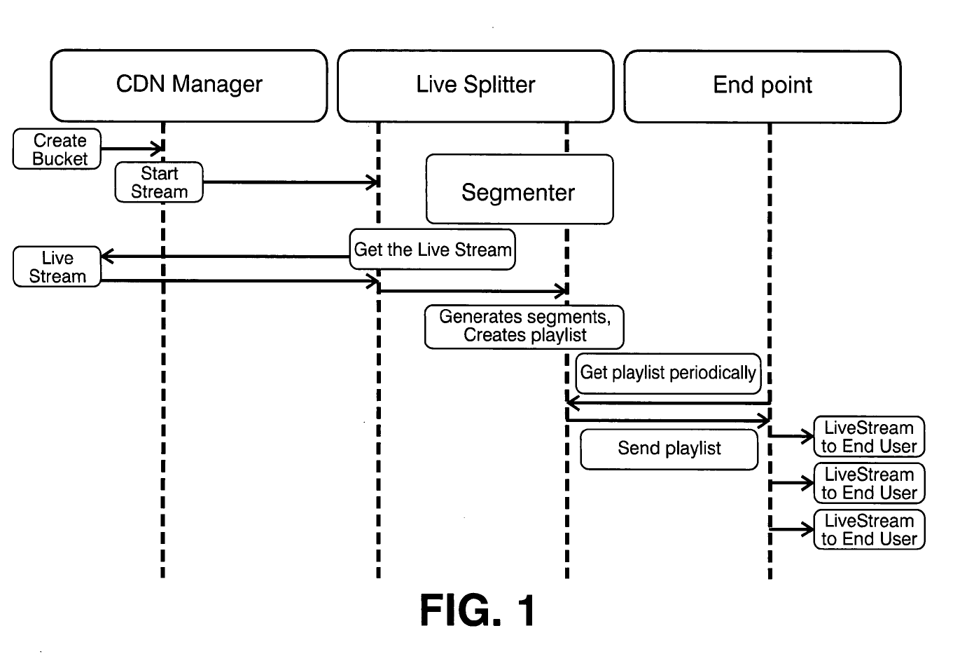

Here, a high level architecture of serving a live stream to a requesting end user is described. FIG. 1 shows the sequence diagram for serving such a live stream.

In all, three CDN elements are involved in the distribution of a live stream; the CDN manager, the live splitter and the end point.

The content owner creates a live-bucket (or container) and associates meta-data with the bucket. This is done via the publishing server in the service provider's CDN. The publishing server connects to the CDN manager.

Once a live bucket is created, the CDN manager issues a command to the live splitter to start the live stream. The live splitter in turn gets the live stream from the live stream source. When the live splitter starts up, it also starts a segmenter. The segmenter is designed to create segments from a live-stream.

Once the live splitter starts up, it launches a segmenter. The live splitter starts downloading the stream from the live stream source. The segmenter gets the live stream at the live splitter and generates segments from the received live stream. These segments reside in a directory of the machine hosting the live splitter that then acts as an origin server for the live stream. The live-splitter builds a playlist (that is really a list of URLs) using the segments created from the live stream. The playlist forms the content of the hdx file.

Processing the Live Stream at the Live-Splitter and end Points:

Here, the details of how a live stream is processed at the live-splitter are explained. The live stream has a segmenter that is launched once the live splitter starts. Once the live splitter gets a live stream, it passes the stream to the segmenter.

A live signal is split at the segmenter into segments, each 5 s in duration. These segments are used to create a playlist. In addition, a meta-information file is created that has the following information (a) segment size (5 s), (b) first and (c) last segment, (d) frame rate, (e) resolution, (f) data rate etc. The live splitter serves as an origin server for live streams.

The segments, meta-data and the playlist are downloaded by the end point via its downloader module. At the end point, the live-stream module implements a scheduler that has three modules, a live-point predictor, a P2P download manager module and a live stream server module. The live point predictor estimates the current segment and the current position of the stream with respect to the live stream point for an end user receiving a live stream. The P2P download manager module is used to get the segments in the playlist generated by the segmenter. This module implements a scheduler that uses a combination of greedy and local-rarest policy. The greedy policy gets segments in the immediate neighbourhood of the current play position. The local-rarest policy gets the segments that will be played a little farther in the future and there are few end points in the neighbourhood that have the segment. The greedy policy ensures that end point will continue to service the request without interruption while the local-rarest policy ensures that the end point is altruistic towards its neighbouring end points. This allows the end point to serve its neighbours so that every neighbourhood end point does not have to get the segments of the hdx file from the origin server (in the case of the live stream, the stream splitter).

It is preferable to have the live-splitter close to the broadcaster sending the stream to avoid loss of quality in the transmission of the live-stream.

Starting and Stopping a Live Stream:

As seen in FIG. 1, the live-splitter is in charge of getting the live stream from the content owner. Once the current time passes the start-time of the live stream, an event is triggered at the live splitter. A consequence of this trigger is that the live stream request is sent to the content owner and the live splitter receives a live stream.

When the current time passes the end-time of the live stream, an event is triggered at the live splitter that results in the closing of the connection between the live splitter and the content owner.

The content owner disabling a live-bucket also disables a live stream and closes the connection with the content owner.

How end Points Builds the Live Stream:

The end points get the meta-data of the live bucket once it is created. This allows the end points that are configured to serve a live stream to identify the origin server for the live stream. To serve a live stream to requesting end users, an end point must get the segments from the origin server of the live stream or from other end points in the same datacenter. In order to do this, an end point uses its neighbourhood manager, downloader and its live-streaming module.

The downloader at an end point is responsible for all access to the Internet (be it the neighbouring nodes or the origin server). The neighbourhood manager at an end point keeps a list of all its neighbours (in the same datacentre). The tracker provides the list of neighbourhood IP addresses to an end point. The neighbourhood manager also keeps track of all neighbours that have a certain file (or segment as is the case in live streaming). Live-streaming module is described next in more detail.

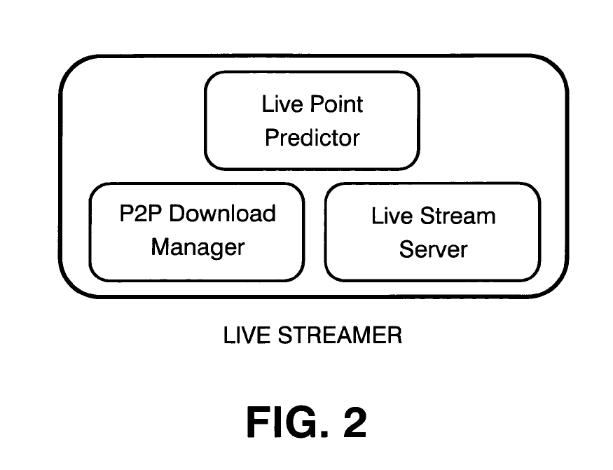

The end point has three sub-modules as shown in FIG. 2 that are part of the live-streaming module: the live point predictor, the P2P download manager and the live stream server. The function of each of the modules in the live streamer at the end point is defined next.

Live Point predictor: This module is responsible for getting the hdr file from the live splitter. This hdr file contains all the header meta-data information about the live content: the frame rate, resolution, data rate, first and last segment, etc.

This module also gets the hdx file from the live splitter periodically. This file has a list of URLs that the P2P Download Manager uses to get the individual segments. This module is also used to estimate the current live point in the stream. This is especially useful if the hdx file is lost or delayed. The receipt of a new hdx file synchronizes the local estimate of current live point against the actual live point at the live splitter that acts as an origin server for the live stream.

P2P Download Manager: The hdx file contains a list of URLs (each of duration 5 s). The live-streaming module knows the current position of the live stream, the current segment that the user is viewing and the size of the buffer. Based on this information, the hdx file and the neighbourhood information, the P2P download manager schedules the segment downloads as per the scheduling algorithm described in [23]. Here, the scheduling in based on a combination of greedy scheduling (getting the segments that are needed for immediate playback) and rarest-first scheduling (the end point downloads the segments that are least replicated among its neighbouring end points).

The buffer allows an end user to perform DVD operations on a live stream. The duration that an end user can go back on a live stream is limited only by the size of the buffer at the end point.

When the P2P download manager downloads a segment, it lets the local neighbourhood manager know of the existence of the new segment. The local neighbourhood manager informs all the other end points engaged in live streaming of the existence of the newly received segment. Not all neighbours go to the live splitter (origin server) to download all files in the hdx. With a random delay of [0-1] seconds, each of the neighbours makes a request for each file in the hdx from one another.

The downloader first checks if requested file is available in the local disks. If it is not available in the local disk, it checks with the neighbourhood manager to see from which neighbour to get the data. Only as a last step does the downloader get the data from the origin server. If there are a large number of neighbours, by introducing the random delay, this scheme allows for neighbours to get the files in the hdx largely from one another without all end points overwhelming the origin server.

Live Stream Server: The live stream server gets the segments from the P2P download manager module and combines them to form a live stream. This stream is then served to requesting end user(s).

The end points request the playlist in the hdx file periodically (every 30 s). Even if the playlist sent from the live splitter is lost or delayed, the end point can predict the URLs of the playlist based on the previous successfully received request (and the time taken to play the segments in the list). In reality, the end points know the size of the buffer ring that is storing the URLs and the current playing point of the sliding window of the playlist).

Once an end user requests a live stream, the end point that will serve the content is identified by the CDN service provider's DNS service. The end point will then request the live stream from the origin server (live splitter) and from other end points in the same datacentre.

How does an end Point Serve a Live Stream?

Once an end user requests a live stream, the end point first checks the meta-data of the live bucket. The end point then ensures that the end user satisfies the following criteria:
The end point first checks the IP address of the end user to ensure that the end user is not subject to geo-blocking.
The end points checks to ensure that the end user request for a live stream is received between the start time and the end time meta-data specified for the live-bucket.

Once the above criteria are satisfied, the end point is ready to serve the requesting end users. The end point already has the address of the live splitter from the meta-data of the live bucket. Since the live splitter serves as the origin server for the live-stream, the end point makes a request for the stream. If an end user arrives after the end time of a live event, the request for the live-stream is denied with an error message generated by the end point.

On receiving a valid live-stream stream request, the end point first gets the hdr file and periodically gets an updated hdx files from the live-splitter. The end point then builds the live stream as discussed above and serves the stream to the requesting end user.

Performing DVD Operations on a Live Stream:

The end point maintains a buffer of the live stream. This allows an end user to perform DVD operations (going back to see an interesting point in the event again) even on a live stream. The duration that an end user may go back in time is limited by the size of the buffer at the end point. This buffer size is really the minimum of the buffer at the live splitter and the serving end point.

Once an end user performs DVD operations (goes back in time) on a live stream, the current playing point is reset. However, the current live point of the stream continues to advance (and so will the last segment that can be stored in the buffer). Based on the algorithm of [23] the P2P download manager will download segments using a strategy that uses a hybrid combination of local-rarest and greedy policy to schedule the segment downloads based on the current segment being played (and the expected play time of subsequent segments).

What Happens when the last end User Leaves an end Point?

The end point maintains a reference count for all the end users who are viewing a live stream. Once an end user leaves (stops viewing) a live stream, the end point closes the socket with the end user and decrements the reference count for the live stream.

When the reference count is equal to zero, the end point stops getting the live stream content from the live splitter.

Advantages of the Invention

The system design has a number of advantages:
By splitting a live stream and creating a playlist, it creates the impression of getting the file from a bucket at an end point.
Use of (multi-source) P2P algorithms that allow the end points in a datacentre to get segments of the video stream from one another. This significantly reduces the load on the live-splitter (that serves as the origin server for the live-stream).
The design of the live-streaming system used in the CDN is a hybrid system; it uses P2P to get content from other end points when possible and from the live splitter (the origin server) when necessary.
By maintaining a buffer on a live stream at the end points, an end user is allowed to do DVD operations on a live stream (pause, go back in time etc.).
By maintaining a buffer on a live stream at the live-splitter, the end points can get content from the live splitter in response to DVD operations on a live stream by an end user.
Use of HTTP as a transport mechanism to deliver the live-stream from an end point to requesting end users.

A person skilled in the art could introduce changes and modifications in the embodiments described without departing from the scope of the invention as it is defined in the attached claims.

### ACRONYMS AND ABBREVIATIONS

ADSL Asymmetric Digital Subscriber Line

CDN Content Distribution Network

DNS Domain Name Service

PoP Point of Presence

URL Uniform Resource Locator

### REFERENCES

[1] S. Annapureddy, S. Guha, C. Gkantsidis, D. Gunawardena and P. Rodriguez. Is High-Quality VoD feasible using P2P Swarming. In WWW, 2007.

[2] B. Cheng, H. Jin and X. Liao. Supporting VCR functions in P2P VoD Services Using Ring-Assisted Overlays. In ICC, 2007.

[3] Y. Huang, T. Z. J. Fu, D. M. Chiu, J. C. S. Lui and C. Huang. Challenges, Design and Analysis of a Large-scale P2P VoD System. In Proc. of Sigcomm, 2008.

[4] A. Hu. Video-on-demand broadcasting protocols: A comprehensive study. In IEEE Infocom, 2001.

[5] K. Almeroth, and M. Ammar. On the use of multicast delivery to provide a scalable and interactive Video-on Demand service. In Journal of Selected Areas in Communications, 1996.

[6] Y. Zhou, D. Chiu and J. Lui. A Simple Model for Analyzing P2P Streaming Protocols. In Proc. of ICNP, 2007.

[7] N. Vratonjic, P. Gupta, N. Knezevic, D. Kostic, A. Rowstron. Enabling DVD-like features in P2P Video-on-Demand-Systems. In ACM P2P-TV Workshop, 2007.

[8] A. Vandat, K. Yocum, K. Walsh, P. Mahadevan, D. Kosti, J. Chase, D. Becker Scalability and Accuracy in a Large-Scale Network Emulator In Proc. of OSDI, 2002.

[9] C. Jin, Q. Chen, S. Jamin. Met: Internet topology generator. Univ. of Michigan TR CSE-TR-433-00, 2000.

[10] C. Dana, D. LI, D. Harrison, and C. Chuah. BASS: Bit-Torrent assisted streaming system for video-on-demand. MMSP, 2005.

[11] A. Vlavianos, M. Iliofotou, and M. Faloutsos Enhancing BitTorrent for supporting streaming applications. In IEEE Global Internet, 2006.

[12] B. Cheng, X. Liu, Z. Zhang, and H. Jin. A Measurement Study of a Peer-to-Peer Video-on-Demand System. IPTPS 2007.

[13] P. Marciniak, N. Liogkas, A. Legout, E Kohler, “Small Is Not Always Beautiful,” In Proc. of IPTPS, 2008.

[14] Yung Ryn Choe, Derek L. Schuff, Jagadeesh M. Dyaberi, Vijay S. Pai, Improving VoD server efficiency with bittorrent In Proc. of IEEE Multimedia 2007.

[15] J. J. D. Mol, J. A. Pouwelse, M. Meulpolder, D. H. J. Epema, and H. J. Sips, Give-to-Get: Free-riding-resilient Video-on-Demand in P2P Systems, MMCN08

[16] Rawflow. At http://en.wikipedia.org/wiki/Rawflow and http://www.rawflow.com

[17] Windows Media Services. At http://en.wikipedia.org/wiki/Windows_Media_Services and http://www.microsoft.com/windows/windowsmedia/forpros/server/server.aspx

[18] Adobe Flash Media Server Family, http://www.adobe.com/products/flashmediaserver/

[19] Youtube. At http://www.youtube.com

[20] Netflix. At http://www.netflix.com

[21] X. Yang, M. Gjoka, P. Chhabra, A. Markopoulou, and P. Rodriguez, “Kangaroo: Video Seeking in P2P Systems,” In Proc. of IPTPS'09, Boston, USA, Apr. 2009

[22] Octoshape. At http://www.octoshape.com and http://en.wikipedia.org/wiki/Octoshape

[23] EP09382307.8, Method for Downloading Segments of a Video File in a Peer-To-Peer Network

1-23. (canceled)

24. Method for distributing live content stream in a Content Delivery Network, comprising serving by an entity of said Content Delivery Network, or CDN, a requested live stream to at least one end user, wherein the method is characterised in that the management and delivery of said requested live stream is performed using a P2P-based architecture, where peers are only end points or content servers of said CDN exchanging content with one another, and where the delivery of said requested live stream to said at least one end user is performed from at least one of said end points, or content server, so that a direct connection is established between said end points or content server and said at least one end user.

25. Method as per claim 24, wherein said end point peers are located in the same datacentre.

26. Method as per claim 24, comprising said end point obtaining said requested live stream in pieces or segments into which the live stream has previously been split.

27. Method as per claim 26, comprising said end point obtaining said segments of a live stream from an origin server and/or from neighbouring end points.

28. Method as per claim 27, wherein said origin server is a live splitter comprising a segmenter, and the method comprises splitting said live stream by means of said segmenter.

29. Method as per claim 28, comprising generating a playlist of links or URLs of said segments by means of said segmenter, and said end point obtaining said segments via said links of the playlist.

30. Method as per claim 29, comprising said at least one serving end point downloading said playlist from said live splitter.

31. Method as per claim 29, comprising said live splitter forwarding said playlist to said at least one serving end point.

32. Method as per claim 31, wherein said playlist links relate to only part of the segments of the whole live stream, the method comprising generating a new playlist with URLs of new segments and periodically forwarding said new playlist to each of the serving end points as an update sent either upon request or automatically.

33. A method as per claim 30 comprising:
a CDN customer or content owner creating a live-bucket or container, and associating meta-data with the bucket, assigning the URL of the live-stream and the address of the live-splitter to the meta-data of said live-bucket;
the CDN manager of the CDN service provider issuing a command to said live splitter to start the live stream once said live bucket is created;
the live splitter upon the reception of said command:
launching the segmenter;
beginning the download of the live stream from the URL provided by the content owner and forwarding the received live stream to the segmenter;
creating and storing the segments from the live stream at the segmenter, generating a playlist from said segments and creating a meta-information header file;
at least one serving end point downloading said playlist of the live-stream, the segments of the playlist and said meta-information header file from the live splitter and receiving periodic updates of URLs of the playlist from the live splitter.

34. A method as per claim 33, comprising closing said established connection on triggering any one of the following events:
the current time at the live splitter passes the end-time of the live stream as specified by the content owner in the bucket metadata of the live stream;
said live stream is stopped by the content owner disabling said live-bucket via the bucket metadata;
the live bucket exceeding the duration for which it may stay active as specified by the content owner in the bucket metadata.

35. A method as per claim 33, wherein said meta-information header file has at least the following information: segment size, first and last segment frame rate, resolution and data rate.

36. A method as per claim 33, wherein said at least one serving end point comprises:
using a live-point predictor module for:
estimating the segment and position of the currently playing stream with respect to the live stream point, and
obtaining said meta-information header file as a hdr file and said playlist as URLs of segments as an hdx file from the live splitter;
obtaining the segments indicated in the playlist in a P2P fashion using a download manager module using a scheduling algorithm that uses information about segments present in other end points from its neighbourhood manager and also using the information provided by the said live-point predictor module, said hdr file, information about the size of the buffer intended for storing the segments; and
combining the received segments to form a live stream and serving the stream to the requesting end users by means of a live stream server module.

37. A method as per claim 36, wherein said scheduling algorithm used by said P2P download manager module at an end point is based on a combination of greedy scheduling for getting the segments that are needed for immediate playback, and rarest-first scheduling for downloading the segments that are least replicated among its neighbouring end points.

38. A method as per claim 36, comprising, said P2P download manager module, first checking if the requested segment is available in its local disks, and if not available:
checking which neighbourhood end point has said segment, and:
downloading the required segment from a neighbourhood end point having the segment, or
if no neighbouring end point has said required segment, downloading the segment from the live splitter that acts as the origin server for the live stream.

39. A method as per claim 38, comprising several end points participating in live streaming, each using their respective P2P download manager modules to download segments from one another after a small random delay and going to the origin server of the live stream to download segments only as a last resort to ensure continuous playback for an end user.

40. A method as per claim 36, comprising said P2P download manager module, on downloading a new segment, informing its neighbouring end points of the existence of the new segment using said neighbourhood manager module.

41. A method as per claim 36, comprising dimensioning said buffer intended for storing the received segments at the end point in order to allow an end user to perform DVD operations on the live stream being served thereto, including rewind operations up to the size of the buffer.

42. A method as per claim 36, comprising said live-point predictor module of said serving end point obtaining said meta-information header file once a live bucket is created by said CDN content owner and the live splitter starting the live stream.

43. A method as per claim 42, comprising said end point serving the live stream to a requesting end user only if he is not subject to geo-blocking and the end user request for a live stream is received between the start time and the end time meta-data of the live-bucket as specified by the content owner.

44. A method as per claim 24, comprising identifying the end point that will serve the requested content via the CDN's DNS service in response to an end user requesting a live stream.

45. A method as per claim 33, comprising said serving end point maintaining a reference count for all the end users viewing the served live stream, and:
once an end point starts serving a requesting end user, incrementing the reference count for that live stream at the end point, and
once an end user leaves a live stream, the end point serving the live stream closing the socket connection with the end user and decrementing said reference count for the live stream at the said end point, and
once the reference count for a live stream is equal to zero, the end point receiving the live stream stops getting the live stream content from the live splitter.

46. A system for distributing live content stream in a Content Delivery Network, for implementing a method according to claim 36 comprising serving by an entity of said Content Delivery Network, or CDN, a requested live stream to at least one end user, wherein the system is characterised in that it comprises a P2P-based architecture, where peers are only end points or content servers of said CDN exchanging content with one another for management and delivery of said requested live stream.

47. A system as per claim 46, wherein said end point or content server comprises a live-stream module implementing a scheduler including a live-point predictor module, a P2P download manager module and a live stream server module, for distributing live content stream .
